(19) United States
(12) Patent Application Publication
(10) Pub. No.: US 2016/0362505 A1
(43) Pub. Date: Dec. 15, 2016

(54) PROCESS FOR THE PRODUCTION OF MODIFIED BUTYL RUBBER

(71) Applicant: ARLANXEO CANADA INC, Sarnia (CA)

(72) Inventors: Dana ADKINSON, London (CA); Sean MALMBERG, Ottawa (CA)

(21) Appl. No.: 15/121,407

(22) PCT Filed: Feb. 27, 2015
(86) PCT No.: PCT/CA2015/050151

§ 371 Date: Aug. 25, 2016

(30) Foreign Application Priority Data
Feb. 27, 2014 (EP) 14156975.6

(51) Int. Cl. C08C 19/32; C08L 101/00; C08L 15/02

(52) U.S. Cl. CPC C08C 19/32; C08L 15/02; C08L 101/00

(57) ABSTRACT

There is provided a process for producing an ionomer comprising the steps of (a) admixing in a mixer a halogenated copolymer with at least one nitrogen and/or phosphorus based nucleophile and (b) extruding the mixture from step (a). The process takes place with high conversion and the resulting ionomer contains a low amount of residual nucleophile and has a low yellowness index.

### FIELD

The present invention relates to modified ionomers and a process for production thereof.

### BACKGROUND

Poly(isobutylene-co-isoprene) or IIR, is a synthetic elastomer commonly known as butyl rubber (or Butyl polymer) which has been prepared since the 1940's through the random cationic copolymerization of isobutylene with small amounts of isoprene (usually not more than 2.5 mol %). As a result of its molecular structure, IIR possesses superior air impermeability, a high loss modulus, oxidative stability and extended fatigue resistance.

Halogenation of butyl rubber produces reactive allylic halide functionality within the elastomer. Conventional butyl rubber halogenation processes are described in, for example, Ullmann's Encyclopedia of Industrial Chemistry (Fifth, Completely Revised Edition, Volume A231 Editors Elvers, et al.) and/or “Rubber Technology” (Third Edition) by Maurice Morton, Chapter 10 (Van Nostrand Reinhold Company© 1987), particularly pp. 297-300.

The development of halogenated butyl rubber (halobutyl) has greatly extended the usefulness of butyl by providing much higher curing rates and enabling co-vulcanization with general purpose rubbers such as natural rubber and styrene-butadiene rubber (SBR). Butyl rubber and halobutyl rubber are high value polymers, as their unique combination of properties (excellent impermeability, good flex, good weatherability, and co-vulcanization with high unsaturation rubbers in the case of halobutyl) make them preferred materials for various applications, such as in making tire inner tubes and tire inner liners.

The presence of allylic halide functionalities allows for nucleophilic alkylation reactions. It has been shown that treatment of brominated butyl rubber (BIIR) with nitrogen and/or phosphorus based nucleophiles, in the solid state, leads to the generation of IIR-based ionomers with interesting physical and chemical properties (see: Parent J. S., Liskova A., Whitney R. A, Resendes R. Journal of Polymer Science, Part A: Polymer Chemistry 43, 5671-5679, 2005; Parent J. S., Liskova A., Resendes R. Polymer 45, 8091-8096, 2004; Parent J. S., Penciu A., Guillen-Castellanos S. A., Liskova A., Whitney R. A. Macromolecules 37, 7477-7483, 2004). The ionomer functionality is generated from the reaction of a nitrogen or phosphorus based nucleophile and the allylic halide sites in the halogenated butyl rubber to produce an ammonium or phosphonium ionic group respectively.

The formation of phosphonium butyl ionomers have been disclosed previously. U.S. Pat. No. 7,662,480 describes the synthesis of phosphonium butyl ionomer by mixing BIIR with 3 molar equivalents based on allylic bromide content BIIR in an internal mixer at 100° C. for 1 hour. This resulted in the complete conversion of all the allylic bromide to the phosphonium ionomer.

Similarly, WO 2012/083419 describes butyl phosphonium ionomers prepared by addition of BIIR to a Brabender internal mixer at 130° C. and 60 rpm. The rubber mixed for a short period before the addition of the TPP (1.2 molar equivalents) and further mixed for 7 to 10 minutes. This process resulted in 65% conversion of the allylic bromide to the phosphonium ionomer.

United States Patent Publication US 2012/0059074 describes butyl ionomer formation by premixing BIIR and TPP (1.2 molar equivalents based on allylic bromide) on a room temperature mill followed by heating the mixture on the mill 100° C. for 1 hour resulting in the complete conversion of all the allylic bromide to the phosphonium ionomer.

United States Patent Publication US 2013/0217833 describes an energy efficient, environmentally favourable process for preparing water and solvent-free rubber ionomers, however, no resulting polymer properties are described by feeding a free-flowing concentrated fluid containing brominated rubber and at least one volatile compound as well as a nitrogen or phosphorous containing nucleophile into an extruder that has a degassing, accumulating and outlet section wherein the brominated rubber is partially reacted to form a rubber ionomer.

In the above references, not all of the nucleophile mixed with the halogenated copolymer is reacted to form the ionomer. The unreacted nucleophile will remain in the polymer as residual nucleophile. The residual nucleophile may further react with oxidizing agents to further form an oxidative derivative of the nucleophile. For some rubber applications, butyl rubber must be compounded and vulcanized to yield useful and durable products. Excess triphenylphosphine (TPP) and triphenylphosphine oxide (TPP=O), however, may negatively affect vulcanization of the ionomer compound and the resulting physical and dynamic properties. The TPP reacts with sulfur to form the corresponding triphenylphosphine sulfide resulting in less available sulfur for vulcanization. Further, TPP reacts with peroxide to form TPP=O, resulting in less available peroxide for vulcanization. In addition, for high purity applications, extractables containing the excess residual nucleophile would not be suitable for such applications.

The phosphonium butyl ionomer polymers of the prior art have a distinct yellow to brownish colouration due to various undesired side and decomposition reactions. This feature is technically unacceptable to consumer in particular for applications such as coatings and films.

There remains a need for a process for the production of ionomers with high conversion and one or more of low residual nucleophile and corresponding derivatives, and low yellowness index.

### SUMMARY

There is provided a process for producing an ionomer comprising at least the steps of
(a) admixing in a mixer a halogenated copolymer with at least one nitrogen and/or phosphorous based nucleophile in an amount of from 0.01 to 1.1 molar equivalents based on the total allylic halide content of the halogenated copolymer, at a temperature in a range of 40 to 200° C. for 0.5 to 30 minutes; and
(b) extruding the mixture from step (a)
at a temperature in a range of 50 to 200° C. for 0.5 to 30 minutes and/or milling the mixture from step (a) in a multi roll mill, preferably a two roll mill for about 0.5-90 minutes at a temperature in a range of 50-200° C.

The resulting ionomer typically contains an amount of residual nucleophile or oxidative derivative thereof between 0-50% based on the original amount of nucleophile added, and a final multiolefin content between 50-100% based on the multiolefin content of the halogenated copolymer.

There is further provided a ionomer produced by reacting a nucleophile with a halogenated copolymer having a total allylic halide content of about 0.05 to 2.0 mol % based on the total allylic halide content of the halogenated copolymer, comprising an amount of residual nucleophile or oxidative derivative thereof in a range of 0 to 50% based on the amount of nucleophile reacted to form the ionomer.

There is further provided an elastomeric compound comprising a cured blend of the ionomer of the present invention and at least one elastomer co-curable with the ionomer.

There is further provided an article of manufacture comprising the elastomeric compound of the present invention.

The process produces ionomer with high conversion and one or more of low residual nucleophile and corresponding derivatives, low yellowness index and low molecular weight breakdown.

Further features will be described or will become apparent in the course of the following detailed description.

### DETAILED DESCRIPTION

The present invention is directed to ionomers and process of making said ionomers. As used herein, the terms “ionomeric isoolefin based copolymer”, “ionomeric copolymer”, “ionomer” may be used interchangeably.

According to the process of the present invention ionomers may be obtained by reacting a halogenated copolymer with a nucleophile in a mixer followed by feeding the mixture into an extruder or a multi roll mill.

The copolymers comprise at least one isoolefin monomer and at least one multiolefin monomer and/or β-pinene, and optionally one or more further copolymerizable monomers. As used herein, “isoolefin copolymers”, “isoolefin-multiolefin copolymers” and “copolymers” are used interchangeably.

Suitable isoolefin monomers include hydrocarbon monomers having 4 to 16 carbon atoms. In one embodiment, isoolefins have from 4-7 carbon atoms. Examples of suitable isoolefins include isobutene (isobutylene), 2-methyl-1-butene, 3-methyl-1-butene, 2-methyl-2-butene, 4-methyl-1-pentene, 4-methyl-1-pentene and mixtures thereof. A preferred isoolefin monomer is isobutene (isobutylene).

Multiolefin monomers copolymerizable with the isoolefin monomers may include dienes, for example conjugated dienes. Particular examples of multiolefin monomers include those having in the range of from 4-14 carbon atoms. Examples of suitable multiolefin monomers include isoprene, butadiene, 2-methylbutadiene, 2,4-dimethylbutadiene, piperyline, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 4-butyl-1,3-pentadiene, 2,3-dimethyl-1,3-pentadiene, 2,3-dibutyl-1,3-pentadiene, 2-ethyl-1,3-pentadiene, 2-ethyl-1,3-butadiene, 2-methyl-1,6-heptadiene, cyclopentadiene, methylcyclopentadiene, cyclohexadiene, 1-vinyl-cyclohexadiene and mixtures thereof. A particularly preferred conjugated diene is isoprene. β-pinene may also be used instead of or in addition to the multiolefin monomer. Herein multiolefin/β-pinene monomers refers to the presence or use of one or more multiolefin monomers and/or β-pinene monomer.

The copolymer may optionally include one or more additional copolymerizable monomers along with the isoolefin and multiolefin/β-pinene monomers. Additional copolymerizable monomers include monomers copolymerizable with the isoolefin and/or multiolefin/β-pinene monomers. Suitable copolymerizable monomers include, for example, styrenic monomers, such as alkyl-substituted vinyl aromatic co-monomers, including but not limited to a C₁-C₄ alkyl substituted styrene. Specific examples of copolymerizable monomers include, for example, α-methyl styrene, ρ-methyl styrene, chlorostyrene, cyclopentadiene and methylcyclopentadiene. In one embodiment, the butyl rubber polymer may comprise random copolymers of isobutylene, isoprene and ρ-methyl stryene.

The copolymers are formed from a mixture of monomers described herein. In one embodiment, the monomer mixture comprises from about 80% to about 99% by weight of an isoolefin monomer and from about 1% to 20% by weight of a multiolefin/β-pinene monomer. In another embodiment, the monomer mixture comprises from about 85% to about 99% by weight of an isoolefin monomer and from about 1% to 15% by weight of a multiolefin/β-pinene monomer. In certain embodiments, three monomers may be employed. In these embodiments, the monomer mixture may comprise about 80% to about 99% by weight of isoolefin monomer, from about 0.5% to about 5% by weight of a multiolefin/β-pinene monomer, and from about 0.5% to about 15% by weight a third monomer copolymerizable with the isoolefin and/or multiolefin/β-pinene monomers. In one embodiment, the monomer mixture comprises from about 68% to about 99% by weight of an isoolefin monomer, from about 0.5% to about 7% by weight of a multiolefin/β-pinene monomer and from about 0.5% to about 25% by weight of a third monomer copolymerizable with the isoolefin and/or multiolefin/β-pinene monomers.

The copolymer may be prepared by any suitable method, of which several are known in the art. For example, the polymerization of monomers may be performed in the presence of AlCl₃ and a proton source and/or cationogen capable of initiating the polymerization process. A proton source includes any compound that will produce a proton when added to AlCl₃ or a composition containing AlCl₃. Protons may be generated from the reaction of AlCl₃ with proton sources such as water, alcohol or phenol to produce the proton and the corresponding by-product. Such reaction may be preferred in the event that the reaction of the proton source is faster with the protonated additive as compared with its reaction with the monomers. Other proton generating reactants include thiols, carboxylic acids, and the like. The most preferred proton source is water. The preferred ratio of AlCl₃ to water is between 5:1 to 100:1 by weight. It may be advantageous to further introduce AlCl₃ derivable catalyst systems, diethylaluminium chloride, ethylaluminium chloride, titanium tetrachloride, stannous tetrachloride, boron trifluoride, boron trichloride, or methylalumoxane. Inert solvents or diluents known to the person skilled in the art for butyl polymerization may be considered as the solvents or diluents (reaction medium). These include alkanes, chloroalkanes, cycloalkanes or aromatics, which are frequently also mono- or polysubstituted with halogens. Hexane/chloroalkane mixtures, methyl chloride, dichloromethane or the mixtures thereof may be preferred. Chloroalkanes are preferably used. The monomers are generally polymerized cationically, preferably at temperatures in the range from −120° C. to +20° C., preferably in the range from −100° C. to −20° C., and pressures in the range from 0.1 to 4 bar.

The copolymer may also be produced via a solution process as outlined in International Patent Publication WO 2011/089083 and references therein. A C6 solvent is a particularly preferred choice for use in a solution process. C6 solvents suitable for use in the present invention preferably have a boiling point of between 50° C. and 69° C. Examples of preferred C6 solvents include n-hexane or hexane isomers, such as 2-methyl pentane or 3-methyl pentane, or mixtures of n-hexane and such isomers as well as cyclohexane.

The copolymer may comprise at least 0.5 mol % repeating units derived from the multiolefin/β-pinene monomers. In some embodiments, the repeating units derived from the multiolefin/β-pinene monomers may be present in the copolymerin an amount of at least 0.75 mol %, or at least 1.0 mol %, or at least 1.5 mol %, or at least 2.0 mol %, or at least 2.5 mol %, or at least 3.0 mol %, or at least 3.5 mol %, or at least 4.0 mol %, or at least 5.0 mol %, or at least 6.0 mol %, or at least 7.0 mol %. In one embodiment, the butyl rubber polymer may comprise from 0.5 to 2.2 mol % of the multiolefin/β-pinene monomers. In another embodiment, the copolymer may comprise higher multiolefin/β-pinene monomer content, e.g. 3.0 mol % or greater. The preparation of suitable high multiolefin/β-pinene butyl rubber polymers is described in Canadian Patent Application 2,418,884.

In one embodiment, the halogenated copolymer may be obtained by first preparing a copolymer from a monomer mixture comprising one or more isoolefins, and one or more multiolefins and/or β-pinene in particular as described above, followed by subjecting the resulting copolymer to a halogenation process to form the halogenated copolymer. Halogenation can be performed according to the process known by those skilled in the art, for example, the procedures described in Rubber Technology, 3rd Ed., Edited by Maurice Morton, Kluwer Academic Publishers, pp. 297-300 and further documents cited therein. Halogenation may involve bromination and/or chlorination. Brominated copolymer may be of particular note. For example, a brominated butyl rubber comprising isobutylene and less than 2.2 mole percent isoprene is commercially available from LANXESS Deutschland GmbH and sold under the name BB2030™.

In the halogenated copolymer one or more of the repeating units derived from the multiolefin monomers comprise an allylic halogen moiety. During halogenation, some or all of the multiolefin and/or β-pinene content of the copolymer is converted to units comprising allylic halides. These allylic halide sites in the halogenated copolymer result in repeating units derived from the multiolefin monomers and/or β-pinene originally present in the non-halogenated copolymer. The total allylic halide content of the halogenated copolymer cannot exceed the starting multiolefin and/or β-pinene content of the parent copolymer, however residual allylic halides and/or residual multiolefins may be present. The allylic halide sites allow for reacting with and attaching one or more nucleophiles to the halogenated copolymer. The halogenated copolymer may have a total allylic halide content from 0.05 to 2.0 mol %. The halogenated copolymer may also contain residual multiolefin levels ranging from 2 to 10 mol %.

The ionomer of the present invention may be obtained by reacting a halogenated copolymer with a nucleophile having no pendant vinyl group, a nucleophile comprising a pendant vinyl group or a mixture thereof. The halogenated copolymer may be reacted first with a nucleophile having no pendant vinyl group and then with a nucleophile having a pendant vinyl group.

Nucleophiles suitable for the preparation of the ionomers may contain at least one neutral phosphorus or nitrogen center, which possess a lone pair of electrons, the lone pair being both electronically and sterically accessible for participation in nucleophilic substitution reactions. The ionomers obtained from such nucleophiles would comprise phosphorus-based or nitrogen-based ionic moieties.

In one embodiment, the allylic halide sites of the halogenated copolymer are reacted with nucleophiles (with or without a pendant vinyl group) having of formula (I):

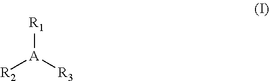

wherein,

A is a nitrogen or phosphorus; and,

R₁, R₂ and R₃ are independently: a vinyl group, a linear or branched C₁-C₁₈ alkyl group; a linear or branched C₁-C₁₈ alkyl group comprising one or more hetero atoms selected from the group consisting of O, N, S, B, Si and P; C₆-C₁₀ aryl group; C₃-C₆ heteroaryl group; C₃-C₆ cycloalkyl group; C₃-C₆ heterocycloalkyl group; or combinations thereof. If the nucleophile has a pendant vinyl group, the vinyl group may be one of R₁, R₂ or R₃ or could be pendant from one or more of the R₁, R₂ or R₃ groups. Two or all three of the R₁, R₂ and R₃ moieties may be fused together.

Suitable nucleophiles include, but are not limited to trimethylamine, triethylamine, triisopropylamine, tri-n-butylamine, trimethylphosphine, triethylphosphine, triisopropylphosphine, tri-n-butylphosphine, triphenylphosphine, diphenylphosphinostyrene, allyldiphenylphosphine, diallylphenylphosphine, diphenylvinylphosphine, triallylphosphine, 2-dimethylaminoethanol, 1-dimethylamino-2-propanol, 2-(isopropylamino)ethanol, 3-dimethylamino-1-propanol, N-methyldiethanolamine, 2-(diethylamino)ethanol, 2-dimethylamino-2-methyl-1-propanol, 2-[2-(dimethylamino)ethoxy]ethanol, 4-(dimethylamino)-1-butanol, N-ethyldiethanolamine, triethanolamine, 3-diethylamino-1-propanol, 3-(diethylamino)-1,2-propanediol, 2-{[2-(dimethylamino)ethyl]methylamino}ethanol, 4-diethylamino-2-butyn-1-ol, 2-(diisopropylamino)ethanol, N-butyldiethanolamine, N-tert-butyldiethanolamine, 2-(methylphenylamino)ethanol, 3-(dimethylamino)benzyl alcohol, 2-[4-(dimethylamino)phenyl]ethanol, 2-(N-ethylanilino)ethanol, N-benzyl-N-methylethanolamine, N-phenyldiethanolamine, 2-(dibutylamino)ethanol, 2-(N-ethyl-N-m-toluidino)ethanol, 2,2′-(4-methylphenylimino)-diethanol, tris[2-(2-methoxyethoxy)ethyl]amine, 3-(dibenzylamino)-1-propanol, N-vinyl caprolactam, N-vinyl phthalimide, 9-vinyl carbazole, N-[3-(dimethylamino)propyl]methacrylamide or mixtures thereof.

To form the ionomer of the present invention the halogenated copolymer and nucleophile are mixed in an internal mixer, for example, a tangential mixer, an intermeshing mixer, a kneader or other mixer commonly used in the rubber industry. The reaction between the nucleophile and the halogenated copolymer may be carried out at an elevated temperature that may range from about 40-200° C. More preferably, the reaction between the nucleophile and the halogenated copolymer may be carried out at a temperature in a range of about 80-200° C. In another embodiment, the reaction between the nucleophile and the halogenated copolymer may be carried out at a temperature in a range of about 100-160° C. The nucleophile and the halogenated copolymer may be combined in a mixer and mixed for 0.5-30 minutes, preferably 1-20 minutes, more preferably 2-15 minutes, and even more preferably 5-10 minutes.

The resulting mixture from the may then be hot fed or cold fed through an extruder for 0.5-30 minutes, preferably 1-20 minutes, more preferably 2-15 minutes, and even more preferably 5-10 minutes.

The extruder may be heated to a temperature in a range of about 50-200° C., preferably about 60-175° C., and more preferably about 80-150° C. The extruder may be also be in combination with other extruders. Alternatively, the resulting mixture can be placed on a multi roll mill, preferably a two roll mill for about 0.5-90 minutes, preferably about 5-60 minutes, and more preferably about 10-30 minutes. The mill may be heated to a temperature in a range of about 50-200° C., preferably about 60-175° C., and more preferably about 80-150° C.

Suitable extruder types include single screw and multiscrew extruders comprising any number of barrels and types of screw elements and other single or multishaft conveying kneaders. Possible embodiments of multiscrew extruders are twin-screw extruders, ring extruders or planetary roller extruders, whereby twin-screw extruders are preferred. The extruder unit may comprise one or more extruders connected in series.

In a particularly preferred embodiment, the nucleophile and halogenated copolymer are first mixed in a mixer and then extruded through an extruder. Mixing in the mixer may be performed at ambient temperature or at temperatures of 40-200° C. Mixing in the mixer may be performed for 0.5-30 minutes. Extruding through the extruder may be performed at a temperature in a range of 80-150° C. Extruding through the extruder may be performed for 0.5-30 minutes.

In another embodiment of the invention, the ionomer may be in a strand, ribbon, pellet, fryable bale or compressed bale form.

To pelletize the ionomer either a dry or underwater pelletizer may be used. If a dry cut pelletizer is used, the temperature of the butyl rubber ionomer before cutting may be in a range of about 0-180° C., preferably about 5-160° C., and more preferably about 25-100° C. If an underwater pelletizer is used, the temperature of the water may be in a range of about 0.1-90° C., preferably about 1-70° C., more preferably about 2-40° C. and even more preferably about 10-30° C. An additive may or may not be added to the water in the underwater pelletizer and may include an emulsifier, an antifoaming agent, wetting agent, dispersant, surfactant, or thickener and may be anionic, cationic or nonionic emulsifier conventionally used for stabilizing oil-in-water emulsions. This effect is based on a reduction in the surface tension between an organic polymer phase and an aqueous phase, caused by the emulsifier. The definition of the emulsifier in particular covers emulsifiers which cause the value of the surface tension between an organic and an aqueous phase to be less than 10 mN/m, preferably less than 1 mN/m. By way of example, the definition covers aliphatic and/or aromatic hydrocarbons having from 8 to 30 carbon atoms which have a hydrophilic terminal group, preferably a sulphonate terminal group, sulphate terminal group, carboxylate terminal group, phosphate terminal group or ammonium terminal group. The definition also covers nonionic surfactants having functional groups, examples being polyalcohols, polyethers and/or polyesters. The definition also covers fatty acid salts, such as the sodium and/or potassium salts of oleic acid, the corresponding salts of alkylarylsulphonic acids and of naphthylsulphonic acid, and also covers condensates thereof, e.g. with formaldehyde, and also covers the corresponding salts of alkylsuccinic acid and of alkylsulphosuccinic acid. Additionally, linear alkyl polyether sulfonates, alkyl polyethylene glycol ethers, polyethylene glycol esters, block copolymers based on ethylene oxide and propylene oxide, glycerol, polyglycerol esters, ethoxylated sorbitan fatty acid esters, alcohol alkoxylates may be suitable emulsifiers. If used, the emulsifier may be added in an amount that the concentration of the emulsifier in water may be about 10-250,000 ppm, preferably about 50-100,000 ppm, and more preferably about 5000-50,000 ppm.

The pelletized ionomer may or may not be dusted. The dusting agent may be present on the surface of the pellet in an amount of about 0.01-10 wt %, preferably about 0.05-5 wt %, and more preferably about 0.1-4 wt %, based on the total weight of the ionomer pellet. Suitable dusting agents include, but are not limited to inorganic fillers such as calcium carbonate, aluminum silicate, calcium stearate, stearic acid, magnesium stearate, clays, talcs, kaolin, barytes, mica, silica, titanium dioxide, etc. as well as resins and polyethylene dust or combinations thereof.

In another embodiment of the invention, the amount of nucleophile reacted with the halogenated copolymer may be in the range of about 0.01-1.1 molar equivalents, more preferably about 0.05-1 molar equivalents, even more preferably about 0.2-0.8 molar equivalents, based on the total molar amount of allylic halide present in the halogenated copolymer. The resulting butyl rubber ionomer preferably possesses about 0.01-10 mol %, more preferably about 0.1-1.0 mol %, even more preferably about 0.2-0.8 mol %, yet even more preferably about 0.2-0.5 mol % of ionomeric moieties. The resulting butyl rubber ionomer may be a mixture of the polymer-bound ionomeric moiety and allylic halide such that the total molar amount of ionomeric moiety and allylic halide functionality are present in an amount not exceeding the original allylic halide content.

In an embodiment of the invention, the ionomer would have an amount of unreacted residual nucleophile or oxidative derivative thereof in a range of about 0-50%, preferably about 0.5-30%, and more preferably about 5-20% based on original amount of nucleophile added to the reaction mixture.

In another embodiment of the invention, the ionomer exhibits a ratio of reacted nucleophile to unreacted residual nucleophile or oxidative derivative thereof of at least 2.0, preferably 2.0 to 100.0, more preferably 2.5 to 100.0 even more preferably 2.5 to 20.0 and yet even more preferably 2.7 to 20.0.

The ionomer produced according to the process of the present invention has improved colour properties making the ionomer particularly suitable for films and coatings. The Yellowness Index, as defined in ASTM E313, is a measure of how far an object departs from a preferred white towards yellow. The Yellowness Index of the polymer, according to an embodiment of the present invention as measured according to ASTM E313 is between about 1-100, preferably between about 10-70, more preferably between about 20-60, even more preferably between about 20-41.

Without being bound to a particular theory, it is believed that the Yellowness Index can be at least partially correlated to polymer breakdown as indicated by the isoprene level in the final polymer. Degradation of the ionomer is most susceptible at the 1,4-isoprene multiolefin segments as opposed to the isobutene segments of the polymer chain. A decrease in the 1,4-isoprene level therefore indicates breakdown of the ionomer. This is not favored for a number of reasons, most notably that a reduction in reactive sites for vulcanization results in a lower state of cure and consequently, an article with poorer physical and dynamic properties.

Such breakdown is believed to proceed with exposure to elevated temperatures for extended time periods. Such conditions, however, are typically required to ensure a high conversion of the nucleophile employed to form the ionomers.
It is, therefore, surprising that the mixing and temperature regime according to the present invention allows both high conversion, while maintaining an acceptable degree of polymer breakdown.
In an embodiment of the invention, the final multiolefin content of the ionomer is between about 50-100%, preferably about 60-99% and more preferably about 75-99% based on the multiolefin content of the halogenated copolymer reacted to form the ionomer.
In another embodiment, the ionomer has a multiolefin content of 0.5 mol % or greater.
In another embodiment, the ionomer has a multiolefin content of from 0.5 mol % to 8.0 mol %, preferably of from 0.5 mol % to 2.0 mol %.
Additional ingredients may be combined with the halogenated copolymer and the nucleophile during the process described above to form a ionomer composite. These ingredients may include one or more of other polymers, elastomers, plastics, fillers, antioxidants, stabilizers, oils, tackifiers, gels, resins, process aides, accelerators, curatives or vulcanizing agents, cure retarders and other ingredients common to the rubber industry. The halogenated copolymer and the nucleophile combined, may be present in an amount of about 1-100 wt %, about 5-99 wt %, about 10-90 wt % or about 15-80 wt % of the total weight of the ionomer composite.

The ionomer described above may be used in a secondary process to form a cured or uncured compound. In either case, the compound may include other polymers, elastomers, plastics, fillers, antioxidants, stabilizers, oils, tackifiers, gels, resins, process aides, accelerators, cure retarders and other ingredients common to the rubber industry. If the ionomer is used in a cured compound, curatives or vulcanizing agents may be added.

Co-curable polymers include, for example, elastomers comprising one or more units of unsaturation. The one or more units of unsaturation are preferably carbon-carbon double bonds, such as in olefins and/or dienes. Diene elastomers are of particular note. The co-curable elastomer may be a butyl rubber elastomer, a non-butyl rubber elastomer or a mixture thereof. Some examples of butyl rubber elastomers include butyl rubber (IIR), bromobutyl rubber (BIIR), chlorobutyl rubber (CIIR), and mixtures thereof. Some examples of particular non-butyl rubber elastomers include isobutylene-methylstyrene (BIMS) rubber (commercially available under the trade name Exxpro™), ethylene propylene rubber (EPR), ethylene propylene diene monomer (EPDM) rubber, butadiene rubber (BR), solution styrene butadiene rubber (sSBR), emulsion styrene butadiene rubber (eSBR), acrylonitrile butadiene rubber (NBR), hydrogenated acrylonitrile butadiene rubber (HNBR), natural rubber (NR), epoxidized natural rubber (ENR), polyurethane (PU), polyisoprene rubber, polyacrylic or polyacrylate (ACM), chloroprene (CR), chlorosulphonylpolyethylene or chlorosulphonatedpolyethylene (CSM), ethylene acrylic (AEM), thermoplastic polyester urethane (AU), thermoplastic polyether urethane (EU), epichlorohydrin (ECO), fluoroethylene propylene-perfluoroalkoxy (FEP or PFA), tetrafluoroethylene/propylene (FEPM or TFE/P), perfluoroelastomer (FFKM/FFPM), fluoroelastomer or fluorocarbon (FKM/FPM), fluorosilicone (FVMQ), silicone (VMQ/PVMQ), polytetrafluoroethylene (PTFE), ethylene vinylacetate (EVA) rubber, ethylene acrylate rubber, polyurethane rubber, polyisobutylene (PIB), chlorinated polyethylene (CPE), polynorbornene rubber (PNB), polysulphide rubber (TR), styrene-butadiene-styrene (SBS), styrene-butadiene rubber (SBR), styrene-butadiene (SB), styrene-isoprene-styrene(SIS), styrene-isoprene-butadiene-styrene (SIBS), atactic polypropylene (APP), isotactic polypropylene, ethylene-propylene copolymer, thermoplastic polyolefin (TPO), amorphous poly alpha olefin (APAO) or polyethylene (PE), ethyl vinyl acetate (EVA) and the like and mixtures thereof.

Fillers may be non-mineral fillers, mineral fillers or mixtures thereof. Non-mineral fillers may include, for example, carbon blacks, rubber gels and mixtures thereof. Suitable carbon blacks are preferably prepared by lamp black, furnace black or gas black processes. Carbon blacks preferably have BET specific surface areas of about 20-200 m²/g. Some specific examples of carbon blacks are SAF, ISAF, HAF, FEF and GPF carbon blacks. Rubber gels are preferably those based on polybutadiene, butadiene/styrene copolymers, butadiene/acrylonitrile copolymers or polychloroprene. Suitable mineral fillers comprise, for example, silica, silicates, clay, bentonite, vermiculite, nontronite, beidelite, volkonskoite, hectorite, saponite, laponite, sauconite, magadiite, kenyaite, ledikite, gypsum, alumina, talc, glass, metal oxides (e.g. titanium dioxide, zinc oxide, magnesium oxide, aluminum oxide), metal carbonates (e.g. magnesium carbonate, calcium carbonate, zinc carbonate), metal hydroxides (e.g. aluminum hydroxide, magnesium hydroxide) or mixtures thereof. Dried amorphous silica particles suitable for use as mineral fillers may have a mean agglomerate particle size in the range of about 1-100 microns, or about 10-50 microns, or about 10-25 microns. Suitable amorphous dried silica may have, for example, a BET surface area, measured in accordance with DIN (Deutsche Industrie Norm) 66131, of about 50-450 square meters per gram. DBP absorption, as measured in accordance with DIN 53601, may be about 150-400 grams per 100 grams of silica. A drying loss, as measured according to DIN ISO 787/11, may be about 0-10 wt %. Suitable silica fillers are commercially sold under the names HiSil™ 210, HiSil™ 233 and HiSil™ 243 available from PPG Industries Inc. Also suitable are Vulkasil™ S and Vulkasil™ N, commercially available from Bayer AG. High aspect ratio fillers may include clays, talcs, micas, etc. with an aspect ratio of at least 1:3. The fillers may include acircular or nonisometric materials with a platy or needle-like structure. The aspect ratio is defined as the ratio of mean diameter of a circle of the same area as the face of the plate to the mean thickness of the plate. The aspect ratio for needle and fiber shaped fillers is the ratio of length to diameter. The high aspect ratio fillers may have an aspect ratio of at least 1:5, or at least 1:7, or in a range of 1:7 to 1:200. High aspect ratio fillers may have, for example, a mean particle size in the range of from 0.001 to 100 microns, or 0.005 to 50 microns, or 0.01 to 10 microns. Suitable high aspect ratio fillers may have a BET surface area, measured in accordance with DIN (Deutsche Industrie Norm) 66131, of between 5 and 200 square meters per gram. The high aspect ratio filler may comprise a nanoclay, such as, for example, an organically modified nanoclay. Examples of nanoclays include natural powdered smectite clays (e.g. sodium or calcium montmorillonite) or synthetic clays (e.g. hydrotalcite or laponite). In one embodiment, the high aspect filler may include organically modified montmorillonite nanoclays. The clays may be modified by substitution of the transition metal for an onium ion, as is known in the art, to provide surfactant functionality to the clay that aids in the dispersion of the clay within the generally hydrophobic polymer environment such as onium ions that are phosphorus based (e.g. phosphonium ions) or nitrogen based (e.g. ammonium ions) and contain functional groups having from 2 to 20 carbon atoms. The clays may be provided, for example, in nanometer scale particle sizes, such as, less than 25 μm by volume. The particle size may be in a range of from 1 to 50 μm, or 1 to 30 μm, or 2 to 20 μm. In addition to silica, the nanoclays may also contain some fraction of alumina. For example, the nanoclays may contain from 0.1 to 10 wt % alumina, or 0.5 to 5 wt % alumina, or 1 to 3 wt % alumina. Examples of commercially available organically modified nanoclays as high aspect ratio mineral fillers include, for example, those sold under the trade name Cloisite® clays 10A, 20A, 6A, 15A, 30B, or 25A.

The ionomer may be present in the blend in an amount of about 1-99 phr, or about 1-90 phr, or about 5-75 phr, or less than 50 phr, or about 1-50 phr, or about 1 phr to less than about 50 phr, or about 10-50 phr, or about 5-30 phr, or about 15-30 phr. Fillers may be present in the blend in an amount of about 1-100 phr, or about 3-80 phr, or about 5-60 phr, or about 5-30 phr, or about 5-15 phr.

Ingredients may be compounded together using conventional compounding techniques. Suitable compounding techniques include, for example, mixing the ingredients together using, for example, an internal mixer (e.g. a Banbury mixer), a miniature internal mixer (e.g. a Haake or Brabender mixer) or a two roll mill mixer. An extruder also provides good mixing, and permits shorter mixing times. It is possible to carry out the mixing in two or more stages, and the mixing can be done in different apparatuses, for example one stage in an internal mixer and one stage in an extruder. For further information on compounding techniques, see Encyclopedia of Polymer Science and Engineering, Vol. 4, p. 66 et seq. (Compounding). Other techniques, as known to those of skill in the art, are further suitable for compounding.

The choice of curing system suitable for use is not particularly restricted and is within the purview of a person skilled in the art. In certain embodiments, the curing system may be sulphur-based, peroxide-based, resin-based or ultraviolet (UV) light-based.

A sulfur-based curing system may comprise: (i) a metal oxide, (ii) elemental sulfur and (iii) at least one sulfur-based accelerator. The use of metal oxides as a component in the sulphur curing system is well known in the art. A suitable metal oxide is zinc oxide, which may be used in the amount of from about 1 to about 10 phr. In another embodiment, the zinc oxide may be used in an amount of from about 2 to about 5 phr. Elemental sulfur, (component (ii)), is typically used in amounts of from about 0.2 to about 2 phr. Suitable sulfur-based accelerators (component (iii)) may be used in amounts of from about 0.5 to about 3 phr. Non-limiting examples of useful sulfur-based accelerators include thiuram sulfides (e.g. tetramethyl thiuram disulfide (TMTD)), thiocarbamates (e.g. zinc dimethyl dithiocarbamate (ZDC)) and thiazyl or benzothiazyl compounds (e.g. mercaptobenzothiazyl disulfide (MBTS)). A sulphur based accelerator of particular note is mercaptobenzothiazyl disulfide.

Peroxide based curing systems may also be suitable, especially for ionomers comprising residual multiolefin content in excess of about 0.2 mol %. A peroxide-based curing system may comprises a peroxide curing agent, for example, dicumyl peroxide, di-tert-butyl peroxide, benzoyl peroxide, 2,2′-bis(tert.-butylperoxy diisopropylbenzene (Vulcup® 40KE), benzoyl peroxide, 2,5-dimethyl-2,5-di(tert-butylperoxy)-hexyne-3, 2,5-dimethyl-2,5-di(benzoylperoxy)hexane, (2,5-bis(tert-butylperoxy)-2,5-dimethyl hexane and the like. One such peroxide curing agent comprises dicumyl peroxide and is commercially available under the name DiCup 40C. Peroxide curing agents may be used in an amount of about 0.2-7 phr, or about 1-6 phr, or about 4 phr. Peroxide curing co-agents may also be used. Suitable peroxide curing co-agents include, for example, triallyl isocyanurate (TAIC) commercially available under the name DIAK 7 from DuPont, N,N′-m-phenylene dimaleimide known as HVA-2 from DuPont or Dow), triallyl cyanurate (TAC) or liquid polybutadiene known as Ricon D 153 (supplied by Ricon Resins). Peroxide curing co-agents may be used in amounts equivalent to those of the peroxide curing agent, or less. The state of peroxide cured articles is enhanced with butyl polymers containing increased levels of unsaturation, for example a multiolefin content of at least 0.5 mol %.

The blend may be cured by resin cure system and, if required, an accelerator to activate the resin cure. Suitable resins include but are not limited to phenolic resins, alkylphenolic resins, alkylated phenols, halogenated alkyl phenolic resins and mixtures thereof. In some cases, curing may be achieved by heating the blend at a suitable curing temperature in the presence of the curing system. The curing temperature may be about 80° C. to about 250° C., or 100° C. to about 200° C., or about 120° C. to about 180° C.

Addition of ionomer as an additive to a co-curable elastomer may result in improvement in one or more of green strength of the uncured blend, flex fatigue ratio, adhesion, tear strength, damping, traction and crack growth resistance as described in EP13183546.4.
Ionomer composites may be shaped into a desired article prior to curing. Articles comprising the cured elastomeric compound include, for example, belts, hoses, shoe soles, gaskets, o-rings, wires/cables, membranes, rollers, bladders (e.g. curing bladders), inner liners of tires, tire treads, shock absorbers, machinery mountings, balloons, balls, golf balls, protective clothing, medical tubing, storage tank linings, electrical insulation, bearings, pharmaceutical stoppers, adhesives, a container, such as a bottle, tote, storage tank, etc.; a container closure or lid; a seal or sealant, such as a gasket or caulking; a material handling apparatus, such as an auger or conveyor belt; a cooling tower; a metal working apparatus, or any apparatus in contact with metal working fluids; an engine component, such as fuel lines, fuel filters, fuel storage tanks, gaskets, seals, etc.; a membrane, for fluid filtration or tank sealing. Additional examples where the ionomers may be used in articles or coatings include, but are not limited to, the following: appliances, baby products, bathroom fixtures, bathroom safety, flooring, food storage, garden, kitchen fixtures, kitchen products, office products, pet products, sealants and grouts, spas, water filtration and storage, equipment, food preparation surfaces and equipment, shopping carts, surface applications, storage containers, footwear, protective wear, sporting gear, carts, dental equipment, door knobs, clothing, telephones, toys, catheterized fluids in hospitals, surfaces of vessels and pipes, coatings, food processing, biomedical devices, filters, additives, computers, ship hulls, shower walls, tubing to minimize the problems of biofouling, pacemakers, implants, wound dressing, medical textiles, ice machines, water coolers, fruit juice dispensers, soft drink machines, piping, storage vessels, metering systems, valves, fittings, attachments, filter housings, linings, and barrier coatings.

### EXAMPLES

### Materials and Reagents

BB2030 (LANXESS), RB301 (LANXESS), Bayprene 210 (LANXESS), zinc oxide (St. Lawrence Chemical Company), carbon black (Cabot), triphenylphosphine (Alfa Aesar), triphenylphosphine oxide (Sigma Aldrich), stearic acid (HM Royal), WBC-41P (5 phr Zinc Oxide, 6.4 phr LANXESS Butyl 301, 10 phr SP1045 Resin, Rhein Chemie), Castor Oil (Alfa Aesar) were all used as received from their respective suppliers.

Compound testing equipment and procedures:

TABLE 1

| Equipment/Test Method | ASTM # |
|---|---|
| MDR 200 (Moving Dye Rheometer) | ASTM D |
| | 5289 |
| Mooney Viscometer | ASTM D |
| | 1646 |
| Alpha Technologies T2000 | ASTM D 412 |
| | ASTM D 624 |
| Yellowness Index | ASTM E313 |

For yellowness index, samples were pressed into a 6″×6″ sheet that was 2 mm thick and placed on a white tile and an average of 5 measurements were taken.

### Example 1

Comparative Example as Described in U.S. Pat. No. 7,662,480:

48 g (100 phr) of LANXESS BB2030™ and 4.7 g (9.7 phr, 3 molar equivalents based on allylic bromide content) of triphenylphosphine were added to a Brabender internal mixer (capacity 75 g) operating at 100° C. and a rotor speed of 60 rpm. Mixing was carried out for a total of 60 minutes. The resulting properties are shown in Table 2, most notably, a significant amount of residual/unbound TPP and its oxidized derivative triphenylphosphine oxide (TPP=O).

### Example 2

Comparative Example as Described in WO 2012083419:

LANXESS BB2030™ (100 phr) was allowed to mix alone for a short period of time before the addition of the TPP (4.3 phr) and mixed for 10 minutes. The resulting properties are shown in Table 2, most notably, a residual/unbound TPP and its oxidized derivative triphenylphosphine oxide (TPP=O) indicating 65% conversion.

### Example 3

Example of the Present Invention

LANXESS BB2030™ (100 phr) was added to a Banbury mixer, followed by the addition of triphenylphosphine (3 phr, 0.6 molar equivalents based on allylic bromide content) and mixed for 6 minutes. The mixture was then passed through a single screw extruder heated to 100° C. The resulting properties are shown in Table 2. Comparison of Example 3 to Example 1 and Example 2 show a lower amount of residual TPP and TPP=O. Additionally, Example 2 and Example 3 demonstrate comparable ionic content, indicating the improved efficiency of the process outlined in Example 3 (84% conversion).

TABLE 2

| | 1,4- | Active | Ionic | Unbound | |
|---|---|---|---|---|---|
| | isoprene | Bromine | Content | TPP/TPP = O | Yellowness |
| | (mol %) | (mol %) | (mol %) | (mol %) | Index |
| Example 1 | 0.54 | 0.10 | 0.82 | 1.34 | 46 |
| Example 2 | 0.57 | 0.24 | 0.54 | 0.38 | 43 |
| Example 3 | 0.57 | 0.27 | 0.50 | 0.18 | 41 |
| Example 4 | 0.40 | 0.20 | 0.40 | 0.45 | 105 |

### Example 4

Comparative Example as Described in US 2013/0217833:

The formation of an ionomer as described in Example 2 of US 2013/0217833 resulted in an ionomer with the resulting properties are shown in Table 2. In addition to residual unbound TPP/TPP=O, a decrease in 1,4-isoprene (denoting polymer breakdown) and significant increase in yellowness index are observed when compared to Example 3.

### Example 5-7

To demonstrate the negative impact of residual TPP/TPP=O on a vulcanized compound, TPP (Example 6) and TPP=O (Example 7) were incorporated into a traditional, butyl-based-resin cured formulation (Example 5) as outlined in Table 3. Referring to Table 4, both the addition of TPP and TPP=O results in poorer state of cure and subsequent poorer compound properties, highlighting the advantage of lower amount of residual TPP and TPP=O.

TABLE 3

| | 5 | 6 | 7 |
|---|---|---|---|
| LANXESS Butyl 301 | 66.25 | 66.25 | 66.25 |
| LANXESS Bromobutyl | 24 | 24 | 24 |
| 2030 | | | |
| LANXESS Baypren 210 | 3.75 | 3.75 | 3.75 |
| Carbon Black, N330 | 50 | 50 | 50 |
| Castor Oil | 5 | 5 | 5 |
| Stearic Acid | 0.5 | 0.5 | 0.5 |
| Zinc Oxide | 2 | 2 | 2 |
| WBC-41P | 12.8 | 12.8 | 12.8 |
| Triphenylphosphine | 0 | 1 | 0 |
| Triphenylphosphine | 0 | 0 | 1 |
| Oxide | | | |

TABLE 4

| | 5 | 6 | 7 |
|---|---|---|---|
| Triphenylphosphine | 0 | 1 | 0 |
| Triphenylphosphine Oxide | 0 | 0 | 1 |

Cure Characteristics

| | | | |
|---|---|---|---|
| Delta M_{H} − M_{L} (dN.m) | 12.69 | 8.29 | 10.88 |

Compound Properties

| | | | |
|---|---|---|---|
| Mooney Viscosity (M_{L} 1 + 4, @ 100° C., | 77 | 77 | 78 |
| MU) | | | |
| Mooney Scorch (t′05, min) | 11 | 17 | 15 |
| Ultimate Tensile (MPa) | 13.1 | 9.4 | 11.4 |
| Ultimate Elongation (%) | 645 | 968 | 692 |
| Stress @ 100 (MPa) | 2.0 | 1.6 | 1.8 |
| Stress @ 300 (MPa) | 6.1 | 3.7 | 4.9 |
| M300/100 | 3.1 | 2.3 | 2.7 |
| Elongation Set (%) | 8 | 22 | 16 |
| Tear Strength Unaged (kN/m) | 53 | 15 | 32 |

All documents cited herein are incorporated herein by reference.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A process for producing an ionomer, the process comprising:
(a) admixing in a mixer a halogenated copolymer with 0.01 to 1.1 molar equivalents of at least one nitrogen and/or phosphorous based nucleophile based on the total allylic halide content of the halogenated copolymer, at a temperature of 40 to 200° C. for 0.5 to 30 minutes to form a mixture; and
(b) extruding the mixture from step (a) at a temperature of 50 to 200° C. for 0.5 to 30 minutes and/or milling the mixture from step (a) in a multi roll mill, for about 0.5-90 minutes at a temperature of 50 to 200° C.

2. The process according to claim 1, wherein the admixing is performed at a temperature of 100 to 160° C.

3. The process according to claim 1, wherein the extruding is performed at a temperature of 80 to 150° C.

4. The process according to claim 1, wherein the admixing is performed for 5 to 10 minutes.

5. The process according to claim 1, wherein the extruding is performed for 5 to 10 minutes.

6. The process according to claim 1, wherein the nucleophile is admixed in an amount of about 0.2 to 0.8 molar equivalents based on the total allylic halide content of the halogenated copolymer.

7. The process according to claim 1, wherein the nucleophile comprises a compound of formula (I): 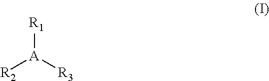
wherein,
A is a nitrogen or phosphorus; and,
R₁, R₂ and R₃ are independently; a vinyl group, a linear or branched C₁-C₁₈ alkyl group; a linear or branched C₁-C₁₈ alkyl group comprising one or more hetero atoms selected from the group consisting of O, N, S, B, Si and P; C₆-C₁₀ aryl group; C₃-C₆ heteroaryl group; C₃-C₆ cycloalkyl group; C₃-C₆ heterocycloalkyl group; or combinations thereof.

8. The process according to claim 1, wherein the nucleophile comprises triphenylphosphine.

9. The process according to claim 1, wherein the halogenated copolymer comprises a halogenated butyl rubber.

10. The process according to claim 1, wherein the halogenated copolymer comprises brominated copolymer.

11. An ionomer obtained according to the process of claim 1.

12. An ionomer produced by reacting a nucleophile with a halogenated copolymer having a total allylic halide content of 0.05 to 2.0 mol % based on the total allylic halide content of the halogenated copolymer, comprising an amount of residual nucleophile or oxidative derivative thereof in a range of 0 to 50% based on the amount of nucleophile reacted to form the ionomer.

13. The ionomer according to claim 12, comprising a Yellowness Index (ASTM E313) of 20-60, and/or a ratio of reacted nucleophile to unreacted residual nucleophile or oxidative derivative thereof of at least 2.0.

14. The ionomer according to claim 12 wherein the amount of the residual nucleophile or derivative thereof is 5 to 20% based on the amount of the nucleophile reacted with the halogenated copolymer.

15. A composite comprising the ionomer according to claim 11.

16. An elastomeric compound comprising a cured blend of the ionomer as defined in claim 11 and at least one elastomer co-curable with the ionomer.

17. An article of manufacture comprising the elastomeric compound as defined in claim 16.

18. The ionomer according to claim 13, wherein the Yellowness index is 20-41 and the ratio of reacted nucleophile to unreacted residual nucleophile or oxidative derivative thereof is 2.5 to 100.0.

19. The ionomer according to claim 18, wherein the ratio of reacted nucleophile to unreacted residual nucleophile or oxidative derivative thereof is 2.7 to 20.0.

20. The process according to claim 10, wherein:
the copolymer comprises at least one isoolefin monomer and at least one multiolefin monomer and/or β-pinene, and optionally one of more further copolymerizable monomers;
the nucleophile comprises triphenylphosphine in an amount of about 0.2 to 0.8 molar equivalents based on the total allylic halide content of the brominated copolymer;
the multi roll mill is a two roll mill;
the admixing is performed at a temperature of 100 to 160° C. for 5 to 10 minutes; and
the extruding is performed at a temperature of 80 to 150° C. for 5 to 10 minutes.
